(19) United States
(12) Patent Application Publication
(10) Pub. No.: US 2026/0007138 A1
(43) Pub. Date: Jan. 8, 2026

(54) Olive Oil Preservation Device

(71) Applicant: Michael Voss, Boulder, CO (US)

(72) Inventor: Michael Voss, Boulder, CO (US)

(21) Appl. No.: 19/259,591

(22) Filed: Jul. 3, 2025

Related U.S. Application Data
(60) Provisional application No. 63/667,898, filed on Jul. 5, 2024.

(51) Int. Cl. A23B 20/10; A23B 2/00; A23B 2/80; F25B 21/02

(52) U.S. Cl. CPC A23B 20/10; A23B 2/001; A23B 2/8055; F25B 21/02; F25B 2321/0212; F25B 2700/02; F25B 2700/2104

(57) ABSTRACT

The present invention relates to an olive oil cooling preservation device designed to extend the shelf life and maintain the quality of olive oil. The device features a thermally conductive aluminum body with an insulating layer and an aesthetically pleasing wood casing. It utilizes a Peltier element controlled by a microcontroller for precise temperature maintenance between 55° F. and 65° F. The device is equipped with a UV-blocking acrylic top closure and is designed to accommodate various container sizes. Advanced features include pulse width modulation for energy efficiency and systems to prevent condensation and protect against light, ensuring optimal preservation conditions for olive oil.

### CROSS REFERENCE TO RELATED APPLICATIONS

This application claims the benefit of priority under 35 U.S.C. § 119 (e) to U.S. Provisional Patent Application No. 63/667,898, filed Jul. 5, 2024, entitled “Olive Oil Preservation Device,” the entire disclosure of which is incorporated herein by reference.

### BACKGROUND OF THE INVENTION

Olive oil is a staple in kitchens worldwide, prized not only for its flavor but also for its health benefits. It is particularly favored by home cooks and health-conscious individuals who often invest in high-quality, expensive olive oils. However, the preservation of olive oil's quality post-opening remains a significant challenge.

Once a bottle of olive oil is opened, it begins to acidify due to exposure to oxygen, light, and heat. This rancidification process significantly reduces the oil's shelf life to approximately two months under typical storage conditions. Current storage methods, such as keeping the oil on countertops or in refrigerators, are fraught with problems. Refrigeration can lead to solidification of the oil, making it difficult to use, and causing the oil to degrade faster, while countertop storage exposes the oil to conditions that accelerate rancidity. Rancid olive oil not only loses its flavor and health benefits but can also be worse for health than consuming no oils at all. This is primarily due to the detrimental effects of oxidized compounds formed during rancidification, a process exacerbated by exposure to ultraviolet light and inappropriate temperatures.

There are currently solutions in the market aimed at cooling beverage bottles to refrigeration temperatures. However, these solutions are not suitable for olive oil as they cool the oil below its optimal preservation temperature, leading to solidification. Moreover, there are no available devices specifically designed to maintain olive oil at the ideal temperature range of 55-65 degrees Fahrenheit, which is above the freezing point but below the temperature that accelerates rancidity.

Given the absence of an effective solution in the market for maintaining olive oil, olive oil-containing solutions such as salad dressings, and similar concoctions at an optimal temperature post-opening, there is a clear need for an innovative device. Such a device would ideally maintain olive oil within a temperature-controlled environment, specifically tailored to prevent rancidity while retaining the oil's fluidity and readiness for immediate use. This invention would not only extend the shelf life of olive oil but also preserve its health benefits and flavor integrity, thereby fulfilling a significant gap in the culinary and health product markets.

### SUMMARY OF THE INVENTION

The preferred embodiment of invention pertains to an olive oil cooling preservation device designed to address the challenge of preserving the quality of olive oil once opened. The device maintains olive oil at an optimal temperature range of 55° F. to 65° F., protecting it from light and ensuring a tight seal to extend its shelf life while preserving its health benefits and flavor. The main body of the device is constructed from aluminum for efficient heat transfer, surrounded by an insulating layer to stabilize internal temperatures. The exterior design includes a wood casing that enhances kitchen aesthetics while providing additional insulation. The device features a top closure, optionally consisting of acrylic, and configured to accommodate various sizes of olive oil containers, optionally comprising of materials that impede ultraviolet light. It incorporates a Peltier element for precise temperature control, managed by a microcontroller using pulse width modulation to adjust cooling power. This innovative solution is tailored for health-conscious consumers and culinary enthusiasts who use high-quality olive oils.

### BRIEF DESCRIPTION OF THE FIGURES

FIG. 1 depicts a top down view of an embodiment of the olive oil preservation device in accordance with an embodiment.

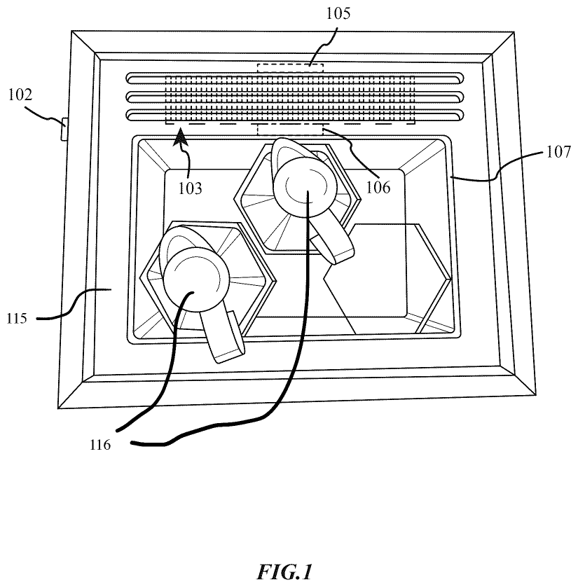

FIG. 2 depicts a perspective view of an embodiment of the olive oil preservation device in accordance with an embodiment.

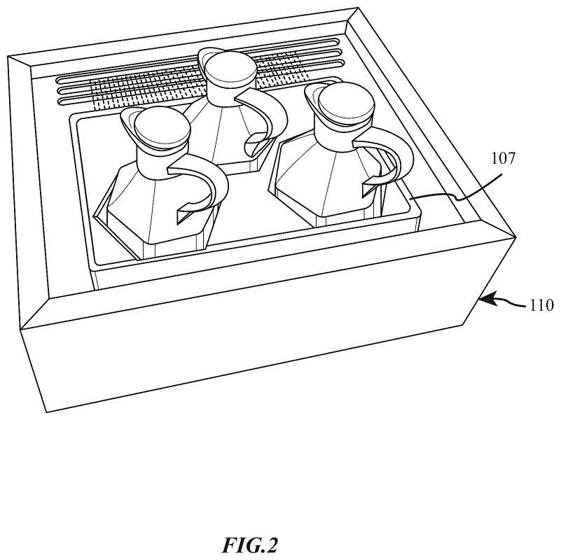

FIG. 3 depicts an exploded view of an embodiment of the olive oil preservation device in accordance with an embodiment.

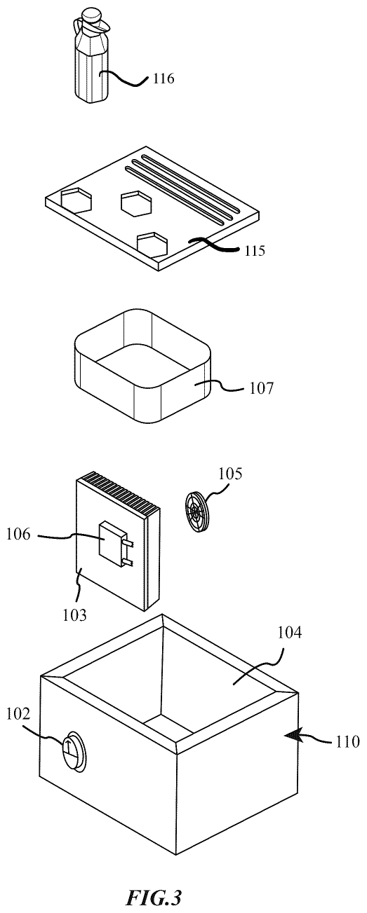

FIG. 4 depicts a schematic of an embodiment of the olive oil preservation device in accordance with an embodiment.

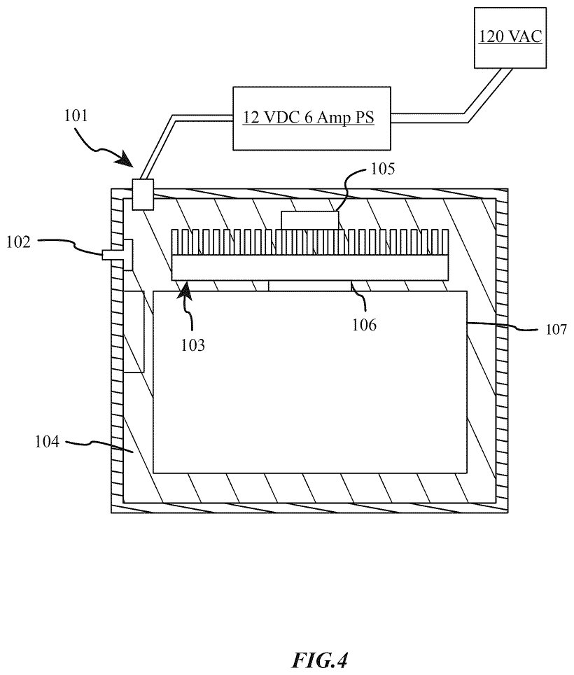

### DETAILED DESCRIPTION

The preferred embodiment of the invention comprises an innovative solution to the problem of preserving the quality of olive oil once the container is opened. By maintaining the oil at a controlled temperature, protecting it from light, and ensuring a tight seal, the device significantly extends the shelf life of olive oil while maintaining its health benefits and flavor, providing utility for health-conscious consumers and culinary enthusiasts.

At its core, the preferred embodiment of the invention comprises an olive oil cooling preservation device designed to maintain olive oil at an optimal temperature range of 55° F. to 65° F. The present inventor recognizes that maintaining this optimal temperature range extends the shelf life of olive oil and preserves its health benefits and flavor. In accordance with various embodiments and exemplary intended uses, the device is tailored for health-conscious consumers and frequent home cooks, especially those who use high-quality olive oils.

The main body of the olive oil cooling preservation device is constructed from aluminum in its preferred embodiment, a material chosen in part for its excellent thermal conductivity. Aluminum's thermal conductivity is crucial for this application because it allows for quick and efficient transfer of heat away from the olive oil containers 116 inside the device. This rapid heat transfer is essential in accordance with the preferred embodiment to quickly bring the olive oil to the desired temperature range and maintain it consistently, despite any external temperature fluctuations.

To enhance the performance of the aluminum enclosure 107, it is equipped with a layer of insulation in an embodiment. This insulation serves as a barrier to external temperature conditions, ensuring that the internal environment of the device remains stable. The choice of insulation material and its thickness are optimized to prevent heat exchange with the outside environment, which is critical in maintaining the precise temperature needed to preserve the olive oil's quality.

The insulation is integrated into the design in such a way that it complements the aluminum's thermal properties. While aluminum efficiently manages the internal temperatures by conducting unwanted heat away from the olive oil, the present inventor has ensured that such configuration of the insulation ensures that this heat does not re-enter any container 116 in an embodiment. This dual-function approach—heat transfer by aluminum and heat blocking by insulation—creates an effective thermal management system that is both responsive and efficient.

The construction of the aluminum enclosure 107 involves techniques that ensure durability and effectiveness. In an example, the aluminum is shaped and welded to form a seamless enclosure 107, minimizing areas where heat could potentially leak. Special attention is given to the joints and seals, which are reinforced to prevent any air leaks that could disrupt the internal temperature stability. The insulation is securely fitted around the body of the aluminum enclosure 107, ensuring complete coverage without any gaps.

Such construction not only supports the functional requirements of the device but also contributes to its longevity and reliability. By using robust construction techniques and high-quality materials, the device is designed to operate effectively for extended periods.

In accordance with the preferred embodiment, the exterior design of the olive oil cooling preservation device comprises a wood casing that partially or fully encloses the aluminum enclosure 107. The choice of wood as a material serves multiple purposes. Firstly, wood is selected for its natural aesthetic appeal, which allows the device to blend seamlessly into a variety of kitchen decors. The present inventor has recognized that the visual appeal of wood makes the device not just a functional appliance but also a decorative element that enhances the overall look of the kitchen space. Wood varieties such as oak, walnut, or maple can be used, each offering unique grain patterns and colors, providing options for personalization according to user preferences or kitchen themes. In an exemplary embodiment, the wood is treated with a food-safe sealant that enhances its durability and resistance to moisture, ensuring it maintains its appearance and structural integrity over time.

Beyond its aesthetic contribution, the wooden exterior 110 plays an important role in the thermal management system of the device. Wood naturally has insulative properties, which complement the insulation within the aluminum enclosure 107. This additional layer of insulation helps in stabilizing the internal temperature by adding another barrier against external temperature fluctuations.

The wood casing 110 in an embodiment is designed to fit snugly around the insulated aluminum enclosure 107, minimizing any gaps that could potentially allow heat exchange. This design consideration assists with the maintenance of the effectiveness of the cooling system, ensuring that the olive oil remains within the desired temperature range without undue energy expenditure.

The integration of the wood exterior 110 with the aluminum enclosure 107 is carefully engineered in accordance with the preferred embodiment. The wood of the wood exterior 110 is precisely cut and assembled to encase the aluminum enclosure 107 completely, ensuring a tight fit that prevents any movement between the two materials. This tight integration helps in maintaining the structural integrity of the device and prevents any air gaps that could compromise its insulative properties.

Special attention is given to the finishing touches of the wood exterior in accordance with the preferred embodiment, including the edges and joins, which are smoothed and sealed to prevent moisture ingress and to ensure ease of cleaning. The design also includes considerations for maintenance, allowing for easy removal of the wood casing if the internal components require servicing or if the exterior needs refinishing.

Embodiments of the olive oil cooling preservation device comprise a top closure. The top closure of the olive oil cooling preservation device is a component designed to maintain the internal environment's integrity. In the preferred embodiment, it is constructed from acrylic, chosen for its durability, clarity, and ease of fabrication. Acrylic is also lightweight and resistant to impact, which is essential for a component that may be frequently handled during the insertion or removal of olive oil containers 116.

In an exemplary method of manufacture, the top closure 115 is fabricated using laser-cutting technology, which allows for high precision in creating the round holes needed to accommodate various sizes of olive oil containers 116. This precision ensures that each hole is perfectly sized to match the containers 116 it is designed to hold, which assists with temperature control.

In an exemplary embodiment, the containers 116 intended to be held within the top closure 115 are customized to fit within apertures of the top closure 115. In various embodiments, the containers 116 comprise a material that impedes light and therefore prevent light penetration into the olive oil or other contents placed therein. The present inventor has recognized the contextual importance of the light impedance and particularly the impedance of ultraviolet light, which can accelerate the rancidity of olive oil.

The design of the top closure 115 in the preferred embodiment further considers ease of use and functionality. In an exemplary embodiment, the acrylic is transparent, allowing users to easily view the containers 116 inside without needing to open the device, thus maintaining the internal temperature and preventing unnecessary exposure to air. The edges of the acrylic of the top closure 115 are smoothed and rounded to ensure user safety during handling.

Furthermore, in an exemplary embodiment, the device incorporates aspects to facilitate easy access to the olive oil containers 116 for removal, replacement or refilling. In an exemplary embodiment, the top closure 115 is designed to be removable or hinged, In one embodiment, the top closure 115 is configured for secure placement upon posts, rods, or other protrusions extending from the aluminum enclosure 107 or other aspects of the device. This feature enhances the user experience by making the device more practical and accessible without compromising the environmental control within the device.

The olive oil cooling preservation device in its preferred embodiment incorporates a Peltier element as its core cooling technology. Peltier elements, also known as thermoelectric coolers, operate based on the Peltier effect, which creates a temperature difference across an electronic junction by transferring heat from one side of the device to the other when an electric current is passed through it. This technology is specifically chosen for its ability to precisely control temperature, which is crucial for maintaining the specific temperature range (55° F. to 65° F.) required to preserve olive oil effectively. The precision in temperature control ensures that the olive oil remains in its optimal state, preventing both overheating and excessive cooling. This element is particularly suitable for applications requiring precise temperature control without moving parts, such as in the described olive oil cooling preservation device.

One of the primary advantages of using a Peltier element in the context of the preferred embodiment is that it operates without any moving parts. This significantly reduces the risk of mechanical failures and contributes to the overall longevity and reliability of the device. Additionally, the absence of moving parts results in quieter operation, making the device more suitable for use in a kitchen environment where noise minimization is often desired. The compact nature of Peltier elements also allows for more flexibility in the design of the device. Their small size and scalability enable the integration of the cooling system within the confined space of the countertop device without compromising its aesthetic and functional design.

Despite the known inefficiency of Peltier elements in terms of energy use compared to traditional cooling methods, this drawback is mitigated in the context of this device by several design choices. The device is well-insulated, which reduces the energy required to maintain the desired temperature. This insulation helps to counteract the inherent inefficiency of the Peltier element by minimizing heat gain from the external environment. Additionally, the device is designed to be always plugged into an outlet and features a mechanism to provide DC power in 101, ensuring a continuous power supply. This setup allows for the use of energy-efficient strategies such as intermittent cooling, where the Peltier element 106 is only activated to maintain the temperature instead of running continuously.

In the olive oil cooling preservation device, the Peltier element 106 is controlled by a microcontroller that utilizes pulse width modulation (PWM) to adjust the cooling power precisely. PWM is a technique where the microcontroller modulates the width of the pulses in a signal to control the amount of power sent to the Peltier element 106. By adjusting the duty cycle—the proportion of time the signal is high to the time it is low—the microcontroller can finely tune how much cooling the Peltier element provides.

This method of control is particularly beneficial for maintaining the specific temperature range required to preserve olive oil effectively (55° F. to 65° F.). The ability to adjust the cooling power with such granularity allows the device to respond dynamically to changes in the internal or external environment. For instance, if the ambient temperature rises, the PWM can increase the duty cycle to provide more cooling and vice versa. This responsive adjustment helps in maintaining a stable temperature, which is crucial for preventing the olive oil from becoming too cold or too warm.

Moreover, the use of PWM enhances the energy efficiency of the Peltier element 106. Peltier elements 106 are not inherently energy-efficient, but by using PWM, the microcontroller ensures that the element 106 only uses the amount of power necessary to maintain the desired temperature. This is a significant improvement over continuous operation at full power, as it reduces electrical consumption and minimizes the heat generated by the element itself. The reduced power usage not only lowers operating costs but also aligns with the energy conservation goals of environmentally conscious consumers.

Additionally, the implementation of PWM in controlling the Peltier element 106 contributes to the overall longevity and reliability of the cooling system. By avoiding the need for the Peltier element 106 to constantly operate at full capacity, PWM reduces wear and tear, thereby extending the lifespan of the element. This is particularly important in a consumer appliance like the presently described invention, where durability and maintenance-minimizing operation are significant considerations.

In accordance with the preferred embodiment of the olive oil cooling preservation device, effective temperature control is paramount to ensure that the olive oil is consistently maintained within the optimal temperature range of 55° F. to 65° F. This is achieved through the integration of a microcontroller, in an embodiment as an Arduino due to its flexibility, ease of use, and extensive support community. The Arduino platform in an exemplary embodiment serves as a cost-effective and adaptable solution for controlling the device's thermal management system, however other microcontrollers are contemplated for utilization in alternative embodiments.

The microcontroller is tasked with regulating the temperature by employing pulse width modulation (PWM) to precisely control the operation of the Peltier element 106. PWM is instrumental in this context as it allows for the modulation of the electrical current's duty cycle supplied to the Peltier element 106, enabling fine adjustments in cooling power. This capability is crucial for responding dynamically to any fluctuations in the internal temperature of the device, thereby maintaining a stable and consistent environment for the olive oil.

In an embodiment of the invention, the device further comprises a thermistor. The thermistor functions in an embodiment as a temperature-sensitive resistor, offering precise temperature readings. In an embodiment, a thermistor continuously monitors the internal temperature, ensuring that the device maintains olive oil at the optimal preservation temperature. The thermistor assists in an embodiment with dynamically adjusting the cooling system to prevent the olive oil from becoming too cold or too warm, thus preserving its quality and extending its shelf life. To ensure accuracy in temperature regulation, in an embodiment the device incorporates a PT100 Resistance Temperature Detector (RTD) or a thermocouple, depending on specific design requirements. These sensors are selected for their high accuracy and reliability in continuous temperature monitoring. The PT100 RTD, known for its precise readings across a broad temperature range, is particularly well-suited for this application. It continuously monitors the internal temperature and provides real-time feedback to the microcontroller, which then adjusts the Peltier element's 106 cooling power accordingly to maintain the desired temperature range.

Embodiments of the olive oil cooling preservation device comprise control mechanisms to enhance the performance of the device. One such embodiment involves the use of a specialized programmable Industrial Control Unit (ICU) instead of an Arduino-based microcontroller. This alternative embodiment is designed to offer more sophisticated control over the device's thermal management system.

An embodiment of the device comprises the integration of a purpose-built microcontroller tailored specifically for the device. This purpose-built microcontroller is configured in accordance with mechanisms well-understood in the art to optimize the operational efficiency and cost-effectiveness of the device in a production environment. The purpose-built microcontroller integrates customized firmware that is specifically engineered to manage the thermal properties of the olive oil cooling preservation device. An embodiment comprising the purpose-built microcontroller allows for more precise control of the Peltier element 106 and other components, ensuring that the olive oil is maintained at the ideal temperature range with greater reliability and energy efficiency. The microcontroller in various embodiments further comprises features such as integrated diagnostics to monitor system performance and predict maintenance needs.

The ICU is selected for its capability to run advanced algorithms that can more precisely manage temperature variations and maintain the optimal temperature range necessary for olive oil preservation. The use of such a control unit allows for the implementation of complex algorithms that can predict and react to changes in environmental conditions more effectively than simpler systems. This proactive approach to temperature management helps in maintaining a consistent internal environment, which is crucial for preserving the quality and extending the shelf life of olive oil.

Moreover, in an embodiment the ICU can potentially enhance the device's energy efficiency. By optimizing the operation of the Peltier element 106 and other components based on real-time data and predictive algorithms, the ICU can minimize the power consumption while maintaining effective cooling. This not only reduces the operational costs but also aligns with the environmental sustainability goals of many consumers.

In an embodiment the ICU is programmed specifically for the needs of olive oil preservation, ensuring that all system parameters are optimized for this purpose. This includes setting the precise temperature thresholds, managing the duty cycle of the PWM for the Peltier element, and integrating feedback from the temperature sensors in a seamless manner. The ICU's programming can be updated or modified as needed, providing flexibility for future improvements or adaptations based on user feedback or new insights into olive oil storage requirements.

In an embodiment, the olive oil cooling preservation device, management of condensation is an aspect of the invention to ensure both the device's optimal operation and the preservation of the olive oil's quality. Condensation can lead to moisture accumulation that might affect the electronic components and the stored olive oil. To address this, the device is engineered to operate above the typical dew point temperature found in most households.

The dew point is the temperature at which air becomes saturated with moisture and begins to condense. Operating above this temperature is important because it prevents the formation of condensation within the device, which could lead to electrical malfunctions or compromise the integrity of the olive oil by introducing unwanted moisture. By maintaining the internal temperature of the device above this threshold, the risk of condensation is significantly minimized.

To achieve this, the device incorporates a temperature control system that continuously monitors the internal environment using precise sensors, such as a PT100 RTD or a thermocouple. These sensors provide real-time data to the microcontroller, which adjusts the cooling power accordingly to ensure the temperature remains above the dew point. This is facilitated by the use of pulse width modulation (PWM) to finely tune the operation of the Peltier element 106, providing just enough cooling to maintain the desired temperature without dipping below the dew point.

Additionally, the device's design includes insulation materials that help in maintaining a stable internal temperature. As described herein in accordance with embodiments, this insulation is not only effective in preventing external temperature fluctuations from affecting the inside of the device but also aids in keeping the internal temperature consistently above the dew point. The choice of materials and the thickness of the insulation are optimized based on typical household temperatures and humidity levels to ensure effectiveness across various environments.

Furthermore, in an exemplary embodiment the device is equipped with a humidity control feature that can activate if sensors detect humidity levels approaching a critical point where condensation could occur. This proactive feature adds an extra layer of protection against condensation, ensuring the longevity of the device and the quality of the olive oil.

In an exemplary embodiment of the olive oil cooling preservation device, the design strategically forgoes active humidity monitoring in favor of enhanced structural features to manage condensation risks. The device incorporates a well-insulated and completely sealed aluminum enclosure 107, designed to minimize the ingress of external humidity and maintain a stable internal environment. This approach ensures that any condensation forming due to temperature differences is contained within the aluminum enclosure 107, where it can be easily wiped away, thus protecting the electronic components and preserving the quality of the olive oil. This design choice simplifies the device while effectively safeguarding it against moisture-related issues, enhancing both the longevity of the device and the integrity of the stored olive oil.

In the preferred embodiment of the olive oil cooling preservation device, container 116 compatibility is a feature to ensure optimal cooling efficiency and user convenience. In the preferred embodiment, the device is engineered to accommodate containers 116 that fit precisely within the base unit, allowing for a seamless integration that maximizes contact with the cooling elements and minimizes any gaps that could lead to inefficient cooling. In such embodiment, the containers 116 are customized and engineered for precise fit within the top closure 115 and therefore form an aspect of the invention.

In accordance with such preferred embodiment, the device designed to work with standard-sized containers 116, in volume sizing commonly used for storing olive oil. For example, the device, in particular the top closure 115, might be tailored to accommodate a standard 500 ml or 750 ml glass or stainless steel olive oil bottle container 116 designed for snug interaction with other aspects of the device, such as the apertures within the top closure 115. The internal dimensions of the device's cooling chamber enclosed by the aluminum enclosure 107 are configured to partially enclose the lower aspects of any container 116 placed therein in an embodiment, ensuring that there is optimal interaction with the cooling elements generating temperature exchange within the interior aspects of such container 116. This design consideration helps in maintaining a uniform temperature throughout any container 116 placed inside of the device, enhancing the preservation quality of the olive oil.

Recognizing the diverse range of olive oil container 116 sizes and shapes available, especially from specialty stores or different regions, an exemplary embodiment of the olive oil cooling preservation device includes specially designed containers 116 that are tailored to fit properly within the device. These containers 116 are engineered to be opaque and well-sealed, optimizing the preservation conditions by protecting the olive oil from light exposure and air. To accommodate the varying dimensions of olive oil containers 116 typically found in the market, the device features adjustable internal components such as modular, removable racks, supports, and top closures 115. These components can be easily reconfigured to snugly fit the specially designed containers 116, ensuring efficient thermal contact and stability within the device. This design approach not only enhances the functional adaptability of the device to different container 116 sizes but also ensures that each container 116 is optimally positioned for maximum preservation efficacy, aligning with the intent to provide a comprehensive and user-friendly olive oil storage solution.

Another exemplary embodiment contemplates the use of a flexible, soft silicone lining within the cooling chamber that can expand or contract to accommodate containers 116 of different diameters while still ensuring good thermal contact with the cooling elements. This material choice not only provides versatility in container 116 size but also adds an additional layer of protection against vibration or shock, which could be beneficial during operation.

In accordance with an exemplary use, a user might purchase a specialty olive oil in a decorative 1-liter bottle from a local market. In accordance with the preferred embodiment of the device, such bottle might not fit and the user would need to transfer the contents from the decorative 1-liter bottle into a standard sized container 116 designed to fit within the device. However, in accordance with the alternative embodiment featuring adjustable racks, the user can reconfigure the internal space to securely accommodate and efficiently cool this larger bottle. Similarly, for smaller or narrower bottles, silicone inserts could be used to ensure a tight fit and effective cooling.

In the preferred embodiment of the olive oil cooling preservation device, protecting the stored olive oil from light exposure, particularly ultraviolet (UV) light, is an important design consideration. The present inventor recognizes UV light is known to accelerate the oxidation and rancidity of olive oil, significantly affecting its flavor, nutritional value, and shelf life. To mitigate this risk, in an embodiment, the containers 116 and top closure 115 used in the device are specifically designed to be completely opaque, effectively blocking all light and providing optimal protection against UV degradation.

In the preferred embodiment, the containers 116 are crafted from materials that inherently block UV light. Common choices include tinted glass, stainless steel, or high-density polyethylene (HDPE), all of which are known for their ability to prevent UV light penetration. For instance, tinted glass in dark colors such as amber or green can absorb UV rays, while stainless steel and HDPE provide a complete barrier against any light exposure. These materials are selected not only for their protective properties but also for their safety, durability, and food compatibility.

The design of the containers 116 in the preferred embodiment also plays a role in light protection. The containers 116 are shaped and constructed to ensure that there are no transparent sections or weak points where light might penetrate. Attention is given to the top closure 115 as well; in an embodiment a top closure 115 configured as a lid or cap is designed to fit snugly, eliminating gaps and ensuring complete coverage. This comprehensive approach to design minimizes any risk of light exposure, even when the container 116 is handled or moved.

In alternative embodiments of the device, additional features might be incorporated to further enhance light protection. For example, the device could include an outer casing with a light-absorbing interior lining, adding another layer of light protection when the container 116 is placed inside the device. Another approach in an embodiment comprises the integration of a light sensor within the device that alerts the user if the internal environment is exposed to light, ensuring that corrective measures can be taken promptly.

In accordance with an exemplary embodiment, a user storing high-quality extra virgin olive oil would benefit significantly from opaque containers 116. Even when the device is placed in areas subject to potential light exposure, such as near kitchen windows, the olive oil remains shielded within its durable, light-proof container 116. This design feature ensures that the olive oil retains its quality and nutritional properties for a longer period, providing the user with a superior product.

In the preferred embodiment of the olive oil cooling preservation device, thermal efficiency is a key focus to ensure energy conservation and effective operation. The design of the preferred embodiment strategically leverages the thermal properties of air, particularly the fact that cold air is denser and tends to settle. This characteristic is utilized to maintain the cold air within the device, thereby minimizing thermal energy loss and enhancing the overall efficiency of the device.

The device in its preferred embodiment is engineered to capitalize on the natural behavior of cold air. By ensuring that the cooling elements are positioned in such a way that the cooled air remains contained within the device, the design prevents the denser, cold air from escaping. This containment is facilitated by the precise construction of the device's enclosure, which includes seals and insulation that prevent warm external air from entering and cold air from exiting. This not only maintains the desired temperature inside the device more consistently but also reduces the workload on the cooling system, thereby saving energy.

Another aspect of the design that contributes to thermal efficiency is the minimal temperature differential between the set temperature of the device and typical room temperature. With the device's set temperature around 60° F. and the average room temperature around 72° F., the small temperature difference reduces the thermal gradient, which naturally decreases the rate of heat transfer into the device. This smaller gradient means that less energy is required to maintain the internal temperature, further enhancing the device's energy efficiency in accordance with the preferred embodiment.

The materials chosen for the device's construction also play a crucial role in its thermal efficiency. As described herein, in accordance with embodiments, insulating materials 104 are used in the walls of the device to help maintain the internal temperature without excessive energy input. These materials are selected for their thermal resistance and compatibility with the overall design and functionality of the device.

In alternative embodiments of the device, additional features might be incorporated to further improve thermal efficiency. For example, the device could include a double-walled construction with vacuum insulation, a technology often used in thermal flasks, which provides superior insulation properties. Another option could be the integration of a smart thermostat that adjusts the cooling power based on real-time temperature readings, reducing unnecessary energy consumption when the optimal temperature is reached.

In an exemplary use, a user who places the device in a kitchen environment will benefit from these thermal efficiency features. Even as the room temperature fluctuates with daily activities and external weather conditions, the device efficiently maintains the set temperature of 60° F. This ensures that the olive oil is stored in ideal conditions without incurring high energy costs, making the device both economically and environmentally beneficial.

In the preferred embodiment of the olive oil cooling preservation device, ensuring ease of accessibility and maintenance is strategically considered. To address this, the device incorporates a design where both the top and bottom layers are constructed from removable acrylic panels. This choice not only facilitates straightforward access to the internal components for maintenance and cleaning but also enhances the overall user experience by simplifying the upkeep of the device.

The removable acrylic panels are designed to be easily detachable without the need for specialized tools. This allows users to quickly open the device for routine maintenance tasks such as cleaning the interior, inspecting the cooling elements, or replacing parts if necessary. The acrylic material is chosen for its durability, clarity, and ease of handling. It provides a lightweight yet sturdy option that can withstand regular removal and replacement, ensuring that the device remains functional and aesthetically pleasing over time.

With the accessibility features provided by the removable panels, users can perform maintenance and cleaning tasks more efficiently. For instance, the interior of the device can accumulate dust or residues from the ambient environment, which can potentially affect its performance. By removing the top acrylic layer 115 users can easily access the interior to clean these residues, ensuring that the device operates at optimal efficiency. Additionally, the smooth surface of the acrylic makes it easy to wipe down and disinfect, helping to maintain a hygienic environment for storing olive oil.

In alternative embodiments of the device, additional features are incorporated to further improve accessibility and maintenance. For example, the device in an embodiment comprises modular internal components that can be individually removed and cleaned. Another embodiment incorporates the use of magnetic catches or simple latch mechanisms for the acrylic panels, which allows tool-free access to the device's interior.

In an exemplary scenario where a user needs to perform a thorough cleaning of the device after several months of use, with the removable acrylic panels, the user can easily detach the top layer, gain access to the interior, and clean any accumulated debris or oil residue. This ease of maintenance ensures that the device remains in good working condition and continues to provide effective cooling and preservation of the olive oil.

In the preferred embodiment of the olive oil cooling preservation device, adjustability is a key feature that enhances user control and customization. The device includes an adjustment mechanism 102 that allows users to set the internal temperature to any point within the operational range of the device. This flexibility is crucial for accommodating different ambient conditions and personal preferences, ensuring that the olive oil is stored under optimal conditions tailored to individual needs.

The adjustment mechanism 102 in an embodiment is integrated into the device's control system, often accessible via a digital interface or a manual dial, in the preferred embodiment integrated onto an exterior aspect of the main body of the device. This interface allows users to easily select and set the desired temperature within the device's operational range, which might typically span from 55° F. to 65° F. The chosen temperature setting is maintained by the device's control systems as described herein, which continuously monitor the internal temperature and adjust the cooling power accordingly.

The ability to adjust the internal temperature is particularly beneficial in environments where ambient conditions can vary significantly. For example, in warmer climates or during summer months, users might prefer to set the device at a lower temperature to counteract the higher room temperatures. Conversely, in cooler conditions, the temperature setting can be adjusted higher to conserve energy while still maintaining the olive oil in its ideal state.

The user interface for adjusting the temperature in varying embodiments is designed to be intuitive and accessible, ensuring that all users, regardless of their technical proficiency, can easily operate the device. In varying embodiments, this user interface comprises labels, simple touch controls, or remote control capabilities via a communicatively connected smartphone app, providing convenience and enhancing user interaction with the device.

In alternative embodiments of the device, additional features might be incorporated to provide even greater control over the temperature settings. For instance, the device in an embodiment comprises a programmable timer or schedule that allows users to set different temperatures for specific times of the day or for particular days of the week. This could be useful for users who want to adjust the storage conditions based on their usage patterns or anticipated changes in ambient temperature.

In accordance with an intended example of use, a user who purchases olive oil that is particularly sensitive to temperature fluctuations. Using the adjustment mechanism 102, the user can precisely set the device to maintain a stable temperature of 57° F., ideal for preserving the delicate flavors and properties of their high-quality oil.

In the preferred embodiment of the olive oil cooling preservation device, careful attention is given to the physical dimensions and structural features to ensure functionality and efficiency. The standard model of the device is compact, measuring 8.25 inches in width, 10.25 inches in height, and 5 inches in depth, making it well-suited for typical kitchen countertops. It accommodates standard-sized olive oil containers 116 in accordance with the preferred embodiment while maintaining a practical footprint for everyday use.

To enhance its functionality, the device is mounted on rubber feet. These feet elevate the unit off the countertop, which not only helps to insulate the device by minimizing direct contact with potentially warm surfaces but also prevents heat transfer from the countertop, thereby enhancing the cooling efficiency. The rubber material of the feet provides additional benefits, such as stability, reducing vibration and noise during operation, which contributes to a more pleasant user experience. The feet further elevate the device off the countertop, creating a space underneath that facilitates the passive cooling of the hot side heat sink 103 of the Peltier element 106. This elevation allows air to be naturally drawn up from under the device by convection. As the air passes through the heat sink 103, it absorbs the heat generated by the Peltier element 106, then exits out of the top of the device. This passive airflow mechanism aids in maintaining the desired internal temperature by efficiently removing excess heat. An embodiment further comprises a fan 105 to facilitate heat transfer via air flow.

Recognizing that different users might have varying needs based on the volume of olive oil they wish to store or the space available on their countertops, various embodiments contemplate alternative sizes. For users with limited space or who store smaller quantities of olive oil, a mini version of the device could be ideal. This smaller version would measure approximately 6″×8″×4″, making it suitable for small apartments or for those who prefer portability. Conversely, for commercial settings or households that consume large amounts of olive oil, a larger version measuring around 12″×15″×8″ could be beneficial, providing ample space to accommodate multiple containers 116 or larger specialty bottles. Additionally, an expandable design could offer flexibility, featuring sliding panels or modular components that can be adjusted based on current needs.

These varied sizes cater to a broad range of uses: the mini version is perfect for individual users or small families and fits easily in tight spaces; the standard version suits most households, offering a balance between capacity and countertop footprint; the large version is ideal for culinary professionals, restaurants, or families that use olive oil extensively; and the expandable design provides adaptability for users whose storage needs may vary over time.

In accordance with an intended use in an example, a culinary enthusiast who often hosts dinner parties might find the standard version of the device perfectly meets their needs, allowing them to store several types of olive oil at optimal temperatures. Alternatively, a small café specializing in Mediterranean cuisine might benefit from the larger version, ensuring that a sufficient quantity of olive oil is always preserved at the ideal temperature and readily available.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

We claim:

1. An olive oil cooling preservation device comprising:
at least one olive oil container;
a main body;
an insulation layer surrounding the main body;
a casing partially or fully enclosing the main body;
a top closure comprising a material that blocks ultraviolet light;
a Peltier element for cooling, and
a microcontroller configured to control the Peltier element using pulse width modulation to adjust cooling power based on internal temperature feedback from a temperature sensor.

2. The olive oil cooling preservation device of claim 1, wherein the casing is made from a selection of oak, walnut, or maple, and treated with a food-safe sealant to enhance durability and moisture resistance.

3. The olive oil cooling preservation device of claim 1, wherein the top closure is removable or hinged to facilitate easy access to olive oil containers placed within the device.

4. The olive oil cooling preservation device of claim 1, wherein the temperature sensor is a PT100 Resistance Temperature Detector or a thermocouple, providing continuous temperature monitoring and feedback to the microcontroller.

5. An olive oil cooling preservation device comprising:
a container compatibility system designed to accommodate various sizes of olive oil containers through adjustable internal components;
a light protection system using opaque materials for the containers and top closure to block all light, particularly ultraviolet light;
a thermal management system utilizing a Peltier element controlled by a microcontroller to maintain a desired temperature range;
a condensation management system designed to operate the device above the dew point temperature to prevent moisture accumulation.

6. The olive oil cooling preservation device of claim 5, wherein the adjustable internal components include modular, removable racks or supports that can be reconfigured to fit different container dimensions.

7. The olive oil cooling preservation device of claim 5, wherein the light protection system includes an outer casing with a light-absorbing interior lining to provide additional protection against light exposure.

8. The olive oil cooling preservation device of claim 5, wherein the thermal management system includes a microcontroller programmed to use pulse width modulation for controlling the Peltier element, optimizing energy use and maintaining precise temperature control.

9. The olive oil cooling preservation device of claim 5, further comprising a humidity control feature that activates if sensors detect humidity levels approaching a critical point where condensation could occur, adding an extra layer of protection against condensation.
